(19) United States
(12) Patent Application Publication
(10) Pub. No.: US 2004/0253490 A1
(43) Pub. Date: Dec. 16, 2004

(54) Method and device for deionizing cooling media for fuel cells

(76) Inventors: Christian Wulff, Mannheim (DE); Stefan Bitterlich, Dirmstein (DE); Hartwig Voss, Frakenthal (DE)

Correspondence Address: NIXON & VANDERHYE, PC, 1100 N GLEBE ROAD, 8TH FLOOR, ARLINGTON, VA, 22201-4714, US

(21) Appl. No.: 10/499,676

(22) PCT Filed: Jan. 15, 2003
(86) PCT No.: PCT/EP03/00356

(30) Foreign Application Priority Data
Jan. 15, 2002 (DE) 102 01 276.8

(51) Int. Cl. H01M 8/04

(52) U.S. Cl. 429/13; 429/26

(57) ABSTRACT

The present invention relates to a process and an apparatus for the deionization of a cooling medium of a fuel cell circulating in a cooling circuit. According to the invention, a liquid deionizing agent is allowed to act at least intermittently on the cooling medium so that the deionizing agent can take up ions from the cooling medium. For this purpose, the fuel cell apparatus (10) of the present invention, which comprises at least one fuel cell (11) and at least one cooling circuit (20) for the fuel cell, has at least one deionization apparatus (23) in which a liquid deionizing agent can act on the cooling medium in the cooling circuit (20). The deionization apparatus can comprise static mixers (28, 34) downstream of which membrane separators (29, 35) are installed.

### DESCRIPTION

The present invention relates to a method for the deionizing cooling media for fuel cells, and to a device for carrying out the method.

Fuel cells are devices in which a fuel, for example methanol, ethanol, hydrogen or corresponding mixtures, is burnt in a controlled manner with a combustion agent, for instance pure oxygen, air, chlorine gas or bromine gas, with the reaction energy liberated being converted not only into thermal energy but also into electric energy. Such fuel cells have been used for a number of decades for generating electric energy, particularly in spaceflight. Owing to their high efficiency, their low or completely absent emission of pollutants and their low noise level in operation, the interest in the use of fuel cells has also increased greatly in other fields in recent years. Particular examples which may be mentioned are motor vehicles and the power station sector.

Fuel cells are typically classified according to the type of electrolyte which separates the anode and cathode chambers from one another. A particularly interesting type of fuel cell which is suitable, in particular, for use in relatively small power stations and for mobile use (for example for powering motor vehicles) is the polymer electrolyte fuel cell. In this type of fuel cell, an ionically conductive membrane is used as electrolyte. An individual solid polymer fuel cell generally comprises a membrane/electrode unit (membrane electrode assembly, MEA) in which an ionically conductive membrane is located between a cathode and an anode. The ionically conductive membrane simultaneously serves as dividing wall and as electrolyte. Catalyst particles which promote the reaction in the fuel cell are located at the interface between the electrodes and the membrane. The electrodes are typically in contact with porous current collectors which additionally stabilize the electrode structure and allow introduction of fuel and combustion agent. Since the operating voltage of a single cell is normally less than 1 volt, most fuel cells are made up of a stack of cells in which a number of individual cells sufficient to generate a higher voltage are stacked on top of one another and connected in series. The typical operating temperature of a polymer electrolyte fuel cell is in the region of 100° C. Although higher temperatures favor the electrochemical reactions, they can lead to damage to the membrane.

Since the electrochemical reaction between the fuel and the combustion agent proceeds exothermically, the fuel cell usually has to be cooled so that the desired operating temperature can be maintained and damage to the membrane can be avoided. Since a relatively large quantity of heat has to be removed at a small temperature difference between operating temperature and ambient temperature, use is typically made of liquid coolants which have a sufficiently high heat capacity. Aqueous coolants are therefore particularly useful.

However, aqueous coolants have the disadvantage that they can contribute to corrosion of the metallic constituents of the cooling circuit and the fuel cell. In addition, a cooling medium which has some electrical conductivity represents a safety problem in fuel cell stacks which are operated at a relatively high voltage, for example at about 50 volt.

If deionized water is used as coolant, this can at the same time be used for humidifying the reactants flowing into the fuel cell in order to ensure sufficient hydration of the polymer membrane. Depending on the operating conditions, it may be necessary to add an antifreeze, for example ethylene glycol, or other additives to the cooling water. However, such additives can decompose into ionic constituents, which further increases the risk of corrosion. In addition, such decomposition products can poison the catalyst particles.

Since the electrical conductivity of an aqueous cooling medium decreases with decreasing ion concentration, it has already been proposed that cooling media for fuel cells be deionized by means of a deionizing agent. For example, U.S. Pat. No. 5,200,278 and WO 00/17951 disclose the installation of filters containing solid ion exchange resins in the cooling circuit, so that the aqueous coolant is substantially deionized before being fed back into the fuel cell stack.

A disadvantage of the known systems is, however, that the resin-like ion exchanger is exhausted after a certain operating time and has to be replaced. This is associated with a high maintenance requirement and high costs.

It is an object of the present invention to simplify the deionization of the cooling medium of a fuel cell so that, firstly, the maintenance intervals are extended and, secondly, when maintenance has to be carried out, the replacement or renewal of the deionizing agent can be carried out simply and inexpensively.

We have found that this object is achieved by use of a liquid deionizing agent. In its most general form, therefore, the present invention provides for the use of a liquid deionizing agent for the deionization of a cooling medium of a fuel cell.

The present inventon also provides a process for the deionization of a cooling medium of a fuel cell which circulates in a cooling circuit, which comprises allowing a liquid deionizing agent to act at least intermittently on the cooling medium so that the deionizing agent can take up ions from the cooling medium. The concentration of the dissolved ions present in the cooling medium is thus reduced and they instead accumulate in the deionizing agent. A particular advantage of the liquid deionizing agent is that it can be conveyed around a dedicated circuit so that regeneration of the deionizing agent or replacement of exhausted deionizing agent by fresh deionizing agent can also be carried out during operation of the fuel cell without the cooling medium circuit being adversely affected.

In a first embodiment, the deionization can be carried out intermittently. As soon as, for example, a conductivity sensor in the cooling circuit registers a rise in the conductivity of the cooling medium, which corresponds to an increase in the ion concentration, the deionizing agent can be made to interact with the cooling medium, for example by means of switchable valves in the cooling circuit, so that part of the ions is removed from the cooling circuit.

In a second embodiment, the cooling medium is deionized continuously. In this case, preference is given to using deionization apparatuses which are integrated into the cooling circuit.

To enable ions dissolved in the cooling medium to be taken up effectively by the liquid deionizing agent, the deionizing agent is advantageously brought into contact with the cooling medium. In the present context, bringing into contact encompasses not only mixing or physical contact of the two liquid media, i.e. cases in which the liquid deionizing agent and the liquid cooling medium have a common interface, but also cases in which two liquids are separated by a further medium which is permeable to ions, for example a membrane.

In a first variant, the deionizing agent and the cooling medium are firstly mixed so that intimate contact between the two media is ensured and the deionizing agent is subsequently separated from the cooling medium again. This can be achieved, for example, by phase separation, for instance by means of a phase separator, or by the use of membrane cell of a membrane module. This enables very long intervals between maintenance work to be realized.

In a preferred embodiment of the process of the invention, the deionization of the cooling medium is carried out continuously during operation of the fuel cell. The separation of the cooling medium from the deionizing agent is preferably likewise carried out continuously.

Suitable apparatuses for continuous or batchwise phase separation are known to those skilled in the art and are used, for example, in chemical process engineering or in plant construction (see, for example: “Chemietechnik”, Dr. Eckhard Ignatowitz, Verlag Europa-Lehrmittel; “Grundlagenoperationen chemischer Verfahrenstechnik”, Wilhelm R. A. Vauck, Hermann A. Müller, Deutscher Verlag für Grundstoffindustrie, Stuttgart 2000).

Membrane modules are widely used in medical, food and chemical technology. Known examples of applications are hemodialysis, the desalination of seawater by means of reverse osmosis or the desalination of dyes by means of nanofiltration. Both polymer membranes and membranes made of ceramic materials are available. They are used in the form of flat, tubular, capillary or spirally wound modules (see, for example: R. Rautenbach, “Membranverfahren—Grundlagen der Modul—und Anlagenauslegung”, Springer Verlag Berlin Heidelberg 1997).

If the liquid deionizing agent is used in such a way that it does not mix with the circulating cooling medium, it can, according to a second variant, be brought into contact with the cooling medium either directly or via a membrane, in particular an ion-permeable membrane. If the deionizing agent is essentially immiscible with the cooling medium, the two can be brought into contact in a vessel in which the deionizing agent is present and through which the cooling medium which forms a second phase flows. If the deionizing agent has a density higher than that of the cooling medium, the latter flows through the deionizing agent from the bottom upward, and vice versa. To ensure a large interfacial area between the two liquid phases, which favors highly effective deionization, the cooling medium preferably enters the vessel through a liquid distributor. It preferably leaves the vessel via a calming zone so as to avoid entrainment of deionizing agent in the cooling medium. The vessel can also be equipped with additional internals such as trays, random packing or ordered packing, as are known to a person skilled in the art from extraction technology (see, for example: K. Sattler, “Thermische Trennverfahren”, 2^{nd} Edition 1995, VCH-Verlagsgesellschaft, Weinheim).

However, the bringing into contact can also be carried out in a membrane contactor in which the interface of the liquid phases is stabilized by a porous membrane. The membrane contactor is particularly advantageous for mobile applications because the separation efficiency is independent of the angle of inclination of the apparatus and mechanical vibration and shocks.

A membrane contactor can also be used when the liquid deionizing agent and the cooling medium are miscible. In this case, the membrane is selectively permeable to the ions to be removed from the cooling medium but not to the deionizing agent. This can be achieved, for example, by the membrane having pores which are larger than the ions to be removed from the cooling medium but smaller than the particles of the deionizing agent. It is possible to achieve this by, for example, use of one or more polymeric deionizing agents whose molecular weight is greater than 200 g/mol, preferably greater than 500 g/mol. However, the required membrane selectivity can also be effected or reinforced by, firstly, using a membrane which has either positive or negative excess charges and, secondly, using a deionizing agent bearing a charge of the same sign.

In a further variant, the deionization can be carried out by means of double Donnan dialysis. Here, use is made of at least two deionizing agents which each have pH values different from that of the cooling medium. This pH difference is the driving force for the diffusion process, so that the ions to be removed from the cooling medium can even be taken off from the cooling medium in a direction opposite to their respective concentration gradients. In one embodiment, the cooling medium flows through between an anion exchange membrane and a cation exchange membrane. Behind the anion exchange membrane there is an aqueous solution having a high pH, for example an NaOH solution, as first deionizing agent. OH⁻ ions diffuse from this into the cooling medium to replace anions which diffuse from the cooling medium into the first deionizing agent located behind the anion exchange membrane. Correspondingly, an aqueous solution having a low pH, for example H₂SO₄ solution, is located as second deionizing agent behind the cation exchange membrane. H₃O⁺ ions diffuse from this second deionizing agent into the cooling medium to replace cations which diffuse from the cooling medium into the second deionizing agent located behind the cation exchange membrane.

In all the abovementioned variants in which the cooling medium is brought into direct or indirect contact with the deionizing agent instead of being mixed therewith, the deionizing agent can be kept in motion to improve mass transfer. This can be achieved by means of a stirring device installed in the abovementioned vessel or the membrane module or by circulation of the deionizing agent via an external circuit by means of a pump.

One or more heat exchangers are usually installed in the cooling circuit. In one variant of the invention, only one cooling circuit is provided and the heat exchanger or exchangers are, for example, in contact with air or water or another suitable cooling medium. However, it is also possible to provide a first cooling circuit (primary circuit) which is in thermal contact with a second circuit (secondary circuit).

When a membrane cell is used, the cooling medium is advantageously cooled prior to the deionization in order to keep the temperature of the solutions which are in contact with the deionizing agent and any membrane low. For this purpose, it is possible, for example, to install the module for the deionization downstream (based on the flow direction of the cooling medium in the first or only cooling circuit) of the coolers or heat exchangers of the first cooling circuit.

Preference is therefore given to using an arrangement in which the warmed cooling medium from the fuel cell is firstly passed through a heat exchanger and is cooled there. The cooling medium is subsequently mixed with the deionizing agent (for example in a static mixer) or brought into contact with the deionizing agent as described above and the deionizing agent and deionized cooling medium are then separated in the same or next modules. Both steps can be carried out in one stage or in a plurality of stages.

As liquid deionizing agents, it is possible to use liquids known per se which are able to bind ions. Binding can be by means of complexation, e.g. as in the case of known complexing agents. Examples of such compounds are sugar acids, citric acid, tartaric acid, nitrilotriacetic acid (NTA), methylglycinediacetic acid (MGDA), ethylenediaminetetraacetic acid (EDTA) and further polyaminopolycarboxylic acids and also polyaminopolyphosphonic acids. If the compounds to be complexed are solids, the liquid deionizing agent is a solution of these compounds in a liquid which may be miscible or immiscible with the cooling medium. The ions can also be bound by means of an ionic interaction. This can, for example, be the case when using amines, quaternized amines or polyamines such as polyethylenimine or polyvinylamine. Mixtures of a complexing agent with a compound which acts via ionic interactions are also possible, for example solutions of complexing agents in such compounds.

For the purposes of the invention, both polymer membranes and membranes comprising ceramic materials can be used as membranes for the membrane modules or membrane separators. It is possible to use both integral membranes, i.e. membranes which consist of a uniform material and also composite membranes, i.e. membranes in which the actual membrane which has the desired separation properties has been applied to one or more coarse-pored support layer(s) which consists of a material different from the membrane. The membranes are used in the form of flat, tubular, capillary or spirally wound modules, as are described, for example, in R. Rautenbach, “Membranverfahren—Grundlagen der Modul—und Anlagenauslegung”, Springer Verlag Berlin Heidelberg 1997.

In the variant in which cooling medium and deionizing agent are essentially immiscible, it is advantageous to use macroporous membranes which have a pore size of preferably more than 50 nm and also have a high porosity, preferably more than 30%. Suitable membrane materials are, in particular, polymers, for example polypropylene, polysulfones, polyether sulfones, polyether ketones. Membrane modules suitable for bringing various phases into contact with one another are marketed, for example, under the name Liqui-Cel® by Celgard. These are modules comprising hollow polypropylene fibers.

In the variant in which the cooling medium and the deionizing agent are miscible, it is advantageous to use membranes which are, as described above, selectively permeable to the ions to be removed from the cooling medium but not to the respective deionizing agent. It is possible to use dialysis, ultrafiltration or nanofiltration membranes known to those skilled in the art, for example membranes made of polyamides, polysulfones, polyether sulfones or polyether ketones, which may be either integral assymetric membranes or composite membranes. The latter can be produced by coating a support layer or by means of interface polymerization.

In one variant of the process, the removal of anions and cations from the cooling medium is carried out in two separate modules. The separation of deionizing agent and cooling medium in the separate modules can occur by the same process or different processes. It is also possible to combine a plurality of modules for the removal and cations and a plurality of modules for the removal of anions. An example is the following arrangement: the cooling medium is firstly passed, in the flow direction of the primary cooling circuit, through a heat exchanger and is thereby cooled. Subsequently (based on the flow direction), part of the cooling medium is fed into a module in which mixing with an MGDA-containing solution occurs. Any cations present are here bound as an MGDA complex. This solution is then separated by means of a membrane module. The permeate is the cooling medium depleted in ions; the retentate, which contains the deionizing agent, is recirculated and once again mixed with inflowing coolant. In the next step, the permeate is mixed with a liquid polyamine which removes anions present from the cooling medium by ionic interaction. The separation of the polyamine from the cooling medium is carried out as described for the complexing agent. As a result, both cations and anions are removed from the cooling medium in a simple manner.

Owing to the high concentration of active functions, large amounts of ions can be bound in such deionizing agents. This is a great advantage over solid ion exchange resins which have a high proportion of nonfunctionalized polymer. Furthermore, when the capacity of the liquids described here is exhausted, they can be removed from the system by means of a simple discharge procedure even by an unskilled person. Apart from lengthened maintenance intervals, the maintenance itself is simplified and less expensive as a result.

The process described removes only ionic constituents from the cooling medium. Thus, for example, glycols can be added as antifreezes. The cooling medium can also further comprise additional corrosion inhibitors, for example the orthosalicic esters described in DE-A 100 63 951. The orthosalicic esters preferably have four identical alkoxide substituents in the form of tetra(alkoxy)silane. Typical examples of suitable salicic esters are pure tetraalkoxysilanes such as tetramethoxysilane, tetraethoxysilane, tetra(n-propoxy)silane, tetra(iso-propoxy)silane, tetra(n-butoxy)silane, tetra(tert-butoxy)silane, tetra(2-ethylbutoxy)silane, tetra(2-ethylhexoxy)silane or tetra[2-[2-(2-methoxyethoxy)ethoxy]ethoxy]silane. The substances mentioned are either commercially available or can be prepared by simple transesterification of one equivalent of tetramethoxysilane with four equivalents of the corresponding longer-chain alcohol or phenol, with methanol being distilled off.

Furthermore, it is possible to use coolants for fuel cell drives which comprise one or more five-membered heterocyclic compounds (azole derivatives) which have two or three heteroatoms selected from the group consisting of nitrogen and sulfur and contain no or at most one sulfur atom and may bear an aromatic or saturated six-membered fused-on ring, if desired in combination with orthosalicic esters. Such coolants are described in more detail

Finally, the present invention also provides a fuel cell apparatus comprising at least one fuel cell and at least one cooling circuit for the fuel cell, wherein at least one deionization apparatus in which a liquid deionizing agent can act on the cooling medium is provided in the cooling circuit.

The deionization apparatus advantageously comprises at least one mixer, for example a static mixer, and a membrane separator. The deionization apparatus can also comprise at least one mixer and a phase separator.

It is possible to use a wide variety of phase separators known per se, as are described, for example, in “Chemietechnik”, Dr. Eckhard Ignatowitz, Verlag. Europa-Lehrmittel; “Grundlagenoperationen chemischer Verfahrenstechnik”, Wilhelm R. A. Vauck, Hermann A. Müller, Deutscher Verlag für Grundstoffindustrie, Stuttgart 2000. Suitable membrane cells are described, for example, in R. Rautenbach, “Membranverfahren —Grundlagen der Modul—und Anlagenauslegung”, Springer Verlag Berlin Heidelberg 1997.

In another embodiment, the fuel cell apparatus of the present invention comprises at least one contactor which ensures direct or indirect contact of deionizing agent and cooling medium. The contactor can have an ion-permeable membrane which separates the cooling medium and the liquid deionizing agent from one another.

The ionic conductivities which can be achieved in the depleted stream by means of the process of the invention and the apparatus of the present invention are usually, depending on the initial conductivity, less than 1 μS/cm.

The present invention is illustrated below with reference to the illustrative embodiments shown in the accompanying drawings.

### In the drawings:

FIG. 1 schematically shows a first embodiment of a fuel cell apparatus according to the present invention comprising a cooling circuit in which two deionization apparatuses in which deionizing medium and cooling medium are mixed are installed;

FIG. 2 shows a variant of the fuel cell apparatus of FIG. 1, in which the cooling medium and the deionizing medium are contacted indirectly rather than mixed; and finally

FIG. 3 shows a variant of the embodiment of FIG. 1, in which deionizing agent and cooling medium are separated by means of a phase separator.

FIG. 1 schematically shows a fuel cell apparatus 10 according to the present invention. The fuel cell apparatus 10 comprises a fuel cell stack 11 which has feed lines 12 for the fuel, for example hydrogen gas, and feed lines 13 for the combustion agent, for example air or oxygen. When gaseous substances are fed in, at least one of the gases fed in is humidified before introduction into the fuel cell stack 11 in order to prevent drying out of the polymer membranes of the fuel cells. The reaction products can leave the fuel cell stack 11 via outlet lines 14, 15. If the fuel cell is operated using pure hydrogen and oxygen, water is formed as reaction product and part of this can be used for humidifying the gases flowing in via the lines 12 and 13. The electric current generated by the fuel cell stack 11 can be conveyed via collecting lines 16, 17 to the positive or negative terminals 18, 19.

The fuel cell apparatus 10 has at least one cooling circuit which is denoted overall by the reference numeral 20. As cooling medium, it is possible to use, for example, water which may, depending on the field of use, contain further auxiliaries such as antifreezes or corrosion inhibitors. A circulation pump 21 which effects transport of the cooling medium is located in the cooling circuit 20. The cooling medium is transported through a heat exchanger 22 which is in thermal contact with, for example, the surrounding air. However, thermal contact with a secondary cooling circuit (not shown) is also possible. Downstream of the heat exchanger 22 in the cooling circuit 20 there is a deionization apparatus 23 through which at least part of the cooling medium stream can be passed. The proportion of the cooling medium stream passed into the deionization apparatus 23 can be varied. In the example depicted, a conductivity sensor 24 which controls a valve facility 25 is installed in the cooling circuit 20. When the conductivity of the cooling medium rises, more cooling medium is introduced into the deionization apparatus 23, and when the conductivity decreases, less cooling medium, or no cooling medium at all, is introduced into the deionization apparatus 23. The part of the cooling medium which is not to be deionized can bypass the deionization apparatus 23 via a bypass line 26.

In the variant shown in FIG. 1, the deionization apparatus 23 comprises a circuit 27 through which a first deionizing agent circulates and a static mixer 28 installed in the circuit 27 and a membrane module 29. In the static mixer 28, the cooling medium and the deionizing agent are brought into intimate contact with one another so that ions can migrate from the cooling medium into the deionizing agent. The fluid mixture formed in this way is introduced into the membrane module 29 and is separated there into a retentate and a permeate. The retentate, which consists essentially of the first deionizing agent and ions with which it has been enriched, is conveyed through a line 31 provided with a pump 30 back into the static mixer 28. The first deionizing agent is, in the case presented, employed for separating off the cations in the cooling medium. An example of a suitable first deionizing agent is a solution of the complexing agent citric acid or methylglycinediacetic acid. The permeate is conveyed via a line 32 into a circuit 33 through which a second deionizing agent circulates and which is once again provided with a static mixer 34 and a membrane module 35. The second deionizing agent serves to remove the anions from the cooling medium and can comprise, for example, liquid polymeric amines. After intimate contact of the fluids, the mixture is conveyed from the static mixer 34 into the membrane module 35 and is there again separated into a permeate and a retentate. The permeate, which consists essentially of deionized cooling medium, is conveyed via a line 36 back into the fuel cell stack 11, while the retentate is conveyed via a line 38 provided with a pump 37 back into the static mixer 34.

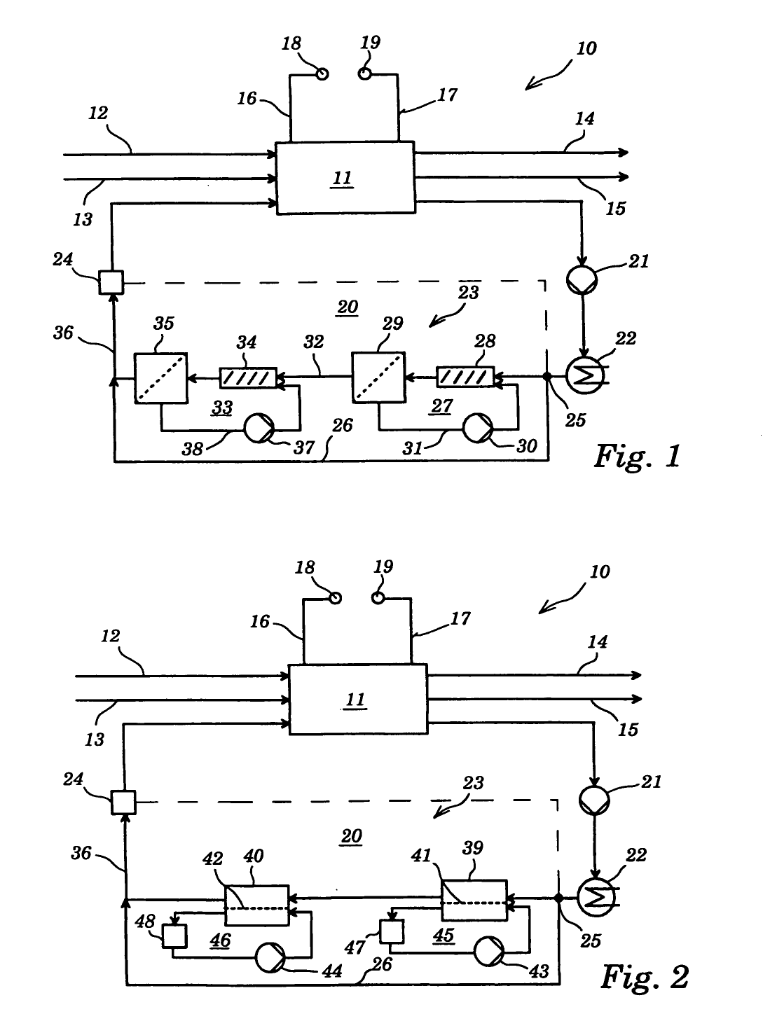

FIG. 2 shows a variant of the embodiment of FIG. 1, in which the cooling medium and the deionizing agent are not mixed but instead brought into indirect contact with one another. Components of the apparatus which correspond to components which have been described in connection with FIG. 1 are denoted by the same reference numerals. In the variant of FIG. 2, the cooling medium which has passed through the heat exchanger 22 is fed in succession into two contactors 39 and 40 which can, for example, be configured as membrane contactors. In these, the deionizing agent and the cooling medium are separated from one another by ion-permeable membranes 41, 42. In the contactors 39, 40 anions and cations are separated off (and replaced by OH⁻ and H⁺ ions, respectively). The deionizing agents are pumped around the circuits 45 and 46 via reservoirs 47 and 48, respectively, by means of pumps 43 and 44. As deionizing agents, it is possible, for example, to use NaOH solution in the circuit 45 and H₂SO₄ solution in the circuit 46.

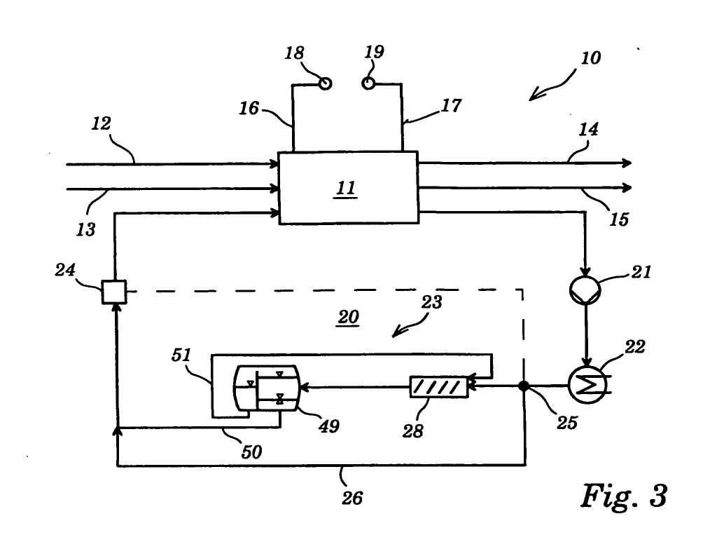

Finally, FIG. 3 shows a single-stage variant of a deionization apparatus of the fuel cell apparatus 10 of FIG. 1, in which the deionizing agent is separated from the cooling medium by phase separation. The other steps are unchanged compared to the variant of FIG. 1. From the static mixer 28, the fluid mixture comprising cooling medium and deionizing agent is fed into a phase separator 49. The lower phase, which comprises the deionized cooling medium, is conveyed via a line 50 back into the fuel cell stack 11. The upper phase comprises the deionizing agent and is recycled via a line 51 to the static mixer 28.

Of course, the circuits 27, 33, 45, 46 and the line 51 in the embodiments outlined above can have connection ports (not shown here) which allow exhausted deionizing agent to be taken off or fresh deionizing agent to be fed in.

1. The use of a liquid deionizing agent for the deionization of a cooling medium of a fuel cell.

2. A process for the deionization of a cooling medium of a fuel cell which circulates in a cooling circuit, which comprises allowing a liquid deionizing agent to act at least intermittently on the cooling medium so that the deionizing agent can take up ions from the cooling medium.

3. A process as claimed in claim 2, wherein the cooling medium is deionized continuously.

4. A process as claimed in claim 2 or 3, wherein the deionizing agent is brought into contact with the cooling medium.

5. A process as claimed in claim 4, wherein the deionizing agent and the cooling medium are mixed and the deionizing agent is subsequently separated from the cooling medium.

6. A process as claimed in claim 5, wherein a phase separator is used for separating the deionizing agent from the cooling medium.

7. A process as claimed in claim 5, wherein a membrane module is used for separating the deionizing agent from the cooling medium.

8. A process as claimed in claim 4, wherein the deionizing agent and the cooling medium are brought into contact with one another either directly or via a membrane.

9. A process as claimed in claim 8, wherein the deionizing agent and the cooling medium have different pH values.

10. A process as claimed in claim 2, wherein a solution of a substance capable of complexing ions is used as deionizing agent.

11. A process as claimed in claim 2, wherein a liquid amine, a dissolved amine or a dissolved quaternized amine is used as deionizing agent.

12. A fuel cell apparatus (20) comprising at least one fuel cell (11) and at least one cooling circuit (20) for the fuel cell, wherein at least one deionization apparatus (23) in which a liquid deionizing agent can act on the cooling medium is provided in the cooling circuit (20).

13. A fuel cell apparatus as claimed in claim 12, wherein the deionization apparatus (23) comprises at least one mixer (28,34) and at least one membrane separator (29,35).

14. A fuel cell apparatus as claimed in claim 12, wherein the deionization apparatus (23) comprises at least one mixer (28) and a phase separator (49).

15. A fuel cell apparatus as claimed in claim 12, wherein the deionization apparatus (23) comprises at least one contactor (39, 40).

16. A fuel cell apparatus as claimed in claim 15, wherein the contactor (39, 40) has an ion-permeable membrane (41, 42) which separates the cooling medium and the liquid deionizing agent from one another.
